(19) United States
(12) Patent Application Publication
(10) Pub. No.: US 2006/0076411 A1
(43) Pub. Date: Apr. 13, 2006

(54) Card reading device

(76) Inventors: Yen-Hung Chen, Hsintien City (TW); Chiu-Kuei Chen, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/962,506

(22) Filed: Oct. 13, 2004

(51) Int. Cl. G06K 7/06

(52) U.S. Cl. 235/441

(57) ABSTRACT

A card reading device includes an insulating housing, at least one set of conductive terminals, and an insulating housing. The insulating plate is combined with the insulating housing, and disposed on the free ends of a plurality of conductive terminals of a set of conductive terminals for providing predetermined force thereto. This configuration makes it simple to assemble the set of conductive terminals and production efficiency is improved.

### BACKGROUND OF THE INVENTION

1. Field of the Invention

The present invention relates to a card reading device, and particularly to a card reading device mounted on a Print Circuit Board (PCB) for retaining an electrical card so as to transmit data between the PCB and the electrical card introduced therein.

2. Description of Related Art

Recently, electrical cards have become widely used in the field of electronic appliances. As such, electrical card connectors are now adapted to connect electrical cards to appliances in which the electrical card connectors are mounted on the PCB of the appliance and retain electrical cards therein, allowing data to be transferred there between.

There currently exist many different kinds of electrical cards of different sizes. Thereby, many kinds of corresponding card reading devices have been created, such as a multi-in-one type card-reading device, in which many different kinds of electrical cards can be used. In these kinds of card reading devices, a plurality of corresponding sets of terminals are needed to electrically connect with the different electrical cards.

Referring to FIG. 1, the conductive terminal set 80 has conductive terminals which are mounted on a insulating housing 90. The insulating housing 90 has a limiting portion 91 thereon for abutting and locating free ends 81 of the conductive terminals 80 to provide a predetermined force thereto.

However, in the process of engaging the conductive terminals 80 to the insulating housing 90, outside forces are needed for pressing the free ends 81 of the conductive terminals 80 downwardly and guiding the free ends 81 extending horizontally into the inside of the limiting portion 91. The free ends 81 can then be released after the extending and locating conductive terminals 80 are inserted into the limiting portion 91. The limiting portion 90 provides the predetermined force for pressing the free ends thereto. This engaging press is complicated and inefficient.

Therefore, it is desirable to provide an improved card reading device for retaining electrical cards that overcomes the above-described disadvantages.

### SUMMARY OF THE INVENTION

An object of the present invention is to provide a card reading device, which has a simple assembly process, and production efficiency is improved.

In order to achieve the objectives set forth, a card reading device in accordance with the present invention includes an insulating housing having a receiving cavity; at least one set of conductive terminals having a plurality of conductive terminals mounted on the insulating housing, each of the conductive terminals has a soldering portion extending out of the insulating housing, and a contact portion extending into the receiving cavity; and an insulating plate combined with the insulating housing, the insulating plate is disposed on free ends of the plurality of conductive terminals for providing the predetermined force thereto. Other objectives, advantages, and novel features of the present invention will became more apparent from the following detailed description when taken in conjunction with the accompanying drawings.

### BRIEF DESCRIPTION OF THE DRAWINGS

FIG. 1 is a schematic, part cross-sectional view of a conventional card reading device, in which a conductive terminal is mating with a limiting portion of an insulating housing.

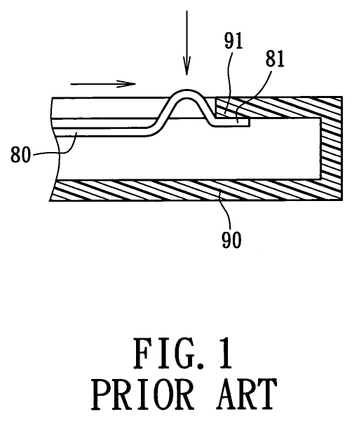

FIG. 2 is an exploded view of a card reading device of a first embodiment in accordance with the present invention.

FIG. 3 is an exploded view of the card reading device of FIG. 2, viewed form another viewing angle.

FIG. 4 is an assembled view of the card reading device of FIG. 2.

FIG. 5 is a schematic, part cross-sectional view of the card reading device according to the first embodiment.

FIG. 6 is an exploded view of a card reading device of a second embodiment in accordance with the present invention.

### DETAILED DESCRIPTION OF PREFERRED EMBODIMENTS

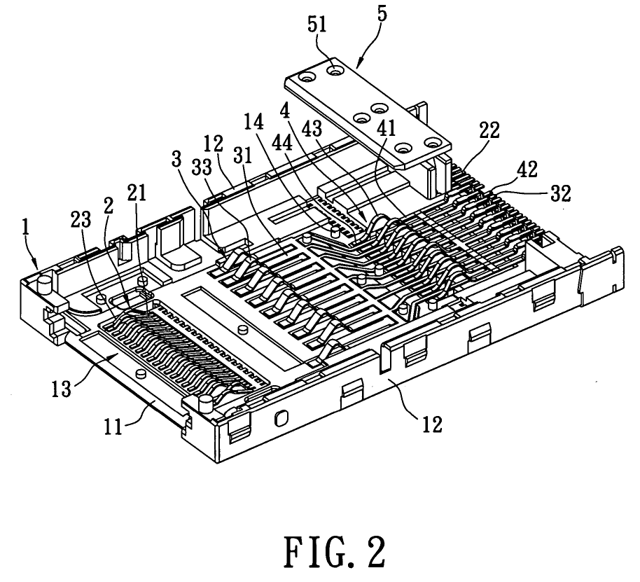

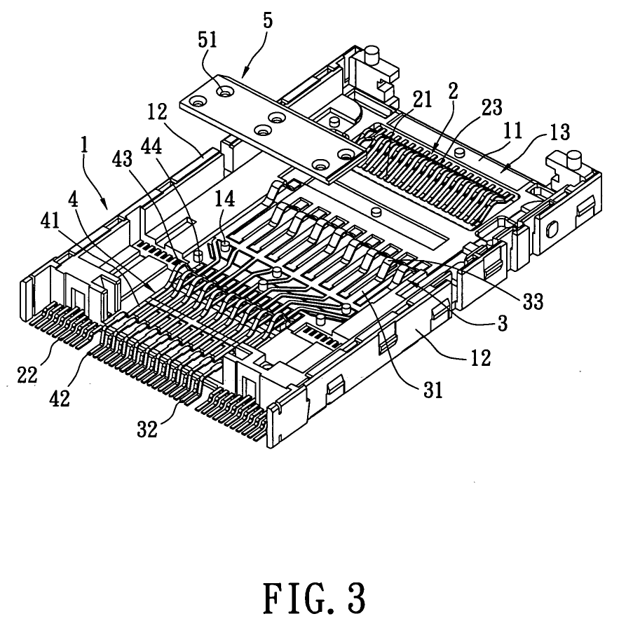

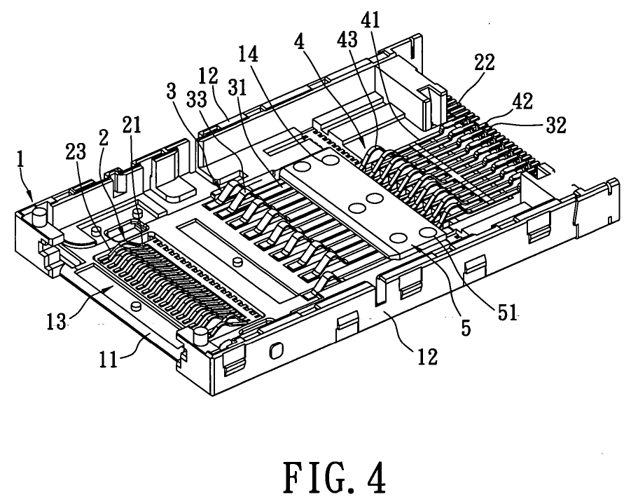

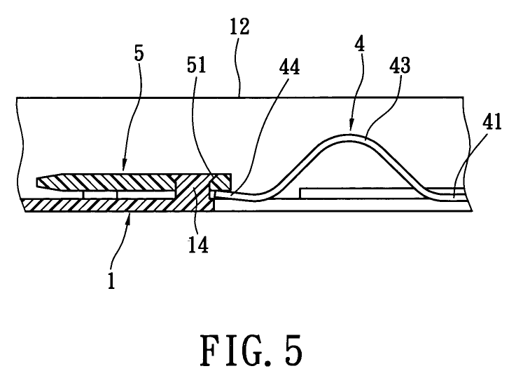

Referring to FIGS. 2-5, a card reading device in accordance with the present invention is shown. The card reading device comprises an insulating housing 1, a first set of conductive terminals 2, a second set of conductive terminals 3, a third set of conductive terminals 4, and a insulating plate 5. The insulating housing 1 is made of a plastic material, which includes a base portion 11, and two arms 12 extending parallel from two ends of the base portion 11 respectively so as to form a receiving cavity 13 for retaining electrical cards.

The first, the second, and the third set of conductive terminals 2, 3 and 4 include a plurality of conductive terminals 21, 31, and 41, respectively. The conductive terminals 21, 31, and 41 are made of an elastic conductive metal material, and are alternately mounted on the base portion 11 of the insulating housing 1 and arranged according to the direction in which the electrical cards are inserted and ejected.

Each of the conductive terminals 21, 31 and 41 has a soldering portion 22, 32 and 42 extending out of a rear end of the insulating housing 1 respectively, which is made by bending each rear end of the conductive terminals 21, 31 and 41 for soldering and electrical connecting with a PCB. Each of the conductive terminals 21, 31 and 41 has a contact portion 23, 33 and 43 extending into a front portion, a middle portion, and a rear portion of the receiving cavity 13 respectively, which is made by bending each front end of the conductive terminals 21, 31 and 41 for electrical connecting with the electrical cards inserted therein. Each of the conductive terminals 41 of the third set of conductive terminals 4 includes a free end 44 disposed adjacent to each of the contact portions 43.

The insulating plate 5 is made of a plastic material, which is disposed upon the insulating housing 1. The insulating plate 5 has a plurality of locating holes 51 therein. The shape and size of the insulating plate 5 and the number of the locating holes 51 are not limited. In this embodiment, the insulating plate 5 is shaped as a planar plate, which has six locating holes 51 therein. Each of the locating holes 51 has a circular cross section. The base portion 11 of the insulating housing 1 further includes a plurality of locating bars 14 corresponding to the locating holes 51. The locating bars 14 are received in the corresponding locating holes 51 so as to combine the insulating plate 5 with the insulating housing 1.

The insulating plate 5 presses the conductive terminals 31 of the second set of the conductive terminals 3 for locating the conductive terminals 31. Moreover, the insulating plate 5 also presses against the free ends 44 of the plurality of conductive terminals 41 of the third set of the conductive terminals 4 for providing the predetermined force and locating the free ends 44 thereto so as to assemble the card reading device in accordance with the present invention.

When inserting an electrical card, the electrical card is pressed into the receiving cavity from above. The electrical conductive portions of the electrical card connected electrical to the contact portions 23, 33 and 43 of the conductive terminals 21, 31 and 41 to make the electrical card connect electrically to the PCB. Conversely, the ejector (not shown) releases the electrical card.

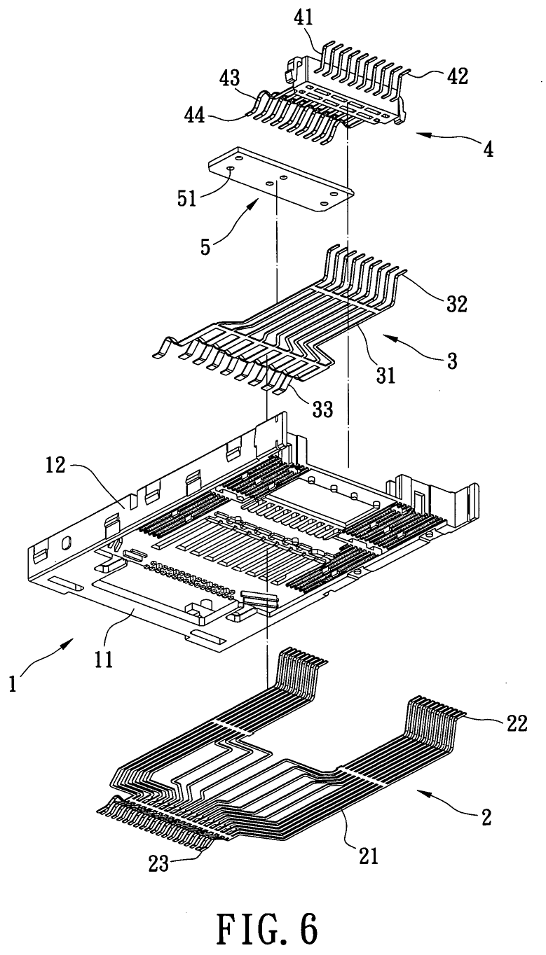

Referring to FIG. 6, an exploded view of a card reading device of a second embodiment in accordance with the present invention is shown. The soldering portions 22, 32 and 42 of the conductive terminals 21, 31 and 41 are inversely soldered so as to make the card reading device mate with the PCB on the other surface thereof.

According to the foregoing description, compared with the conventional card reading device, the card reading device according to the present invention has the following advantages.

First, the insulating plating 5 mates with the insulating housing 1 by connecting with a base portion 11 thereof, then the conductive terminals 41 of the third set of the conductive terminals 4 can be pre-engaged in the insulating housing 1 before locating the insulating plate 5. After assembly, the insulating plate 5 presses against the free ends 44 of the plurality of conductive terminals 41 for providing the predetermined force thereto so as to connect the conductive terminals 41 to the insulating housing 1 without outside pressure. Thereby it is simple to assemble the set of the conductive terminals and the insulating housing and production efficiency is improved.

Secondly, the insulating plate 5 is mounted on the insulating housing 1 by a fixing, riveting, curing or similar process, the mating process is simple and the configuration is stable.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A card reading device comprising:
an insulating housing having a receiving cavity;
at least one set of conductive terminals having a plurality of conductive terminals mounted on the insulating housing, each of the conductive terminals has a soldering portion extending out of the insulating housing, and a contact portion extending into the receiving cavity; and
an insulating plate combined with the insulating housing, the insulating plate is disposed on the free ends of the plurality of conductive terminals for providing the predetermined force thereto.

2. The card reading device as claimed in claim 1, wherein the insulating housing further comprises a base portion, and two arms extending parallel from two ends of the base portion respectively so as to form the receiving cavity.

3. The card reading device as claimed in claim 1, wherein the at least one set of conductive terminals comprises a first set of conductive terminals, a second set of conductive terminals, and a third set of conductive terminals, the insulating plate is disposed on the free ends of the conductive terminals of the third set of conductive terminals for providing the predetermined force thereto.

4. The card reading device as claimed in claim 1, wherein the insulating plate further comprises a plurality of locating holes therein, the insulating housing further having a plurality of locating bars thereon, the locating bars receiving in the corresponding locating holes so as to combine the insulating plate with the insulating housing.
